(19) United States
(12) Patent Application Publication
(10) Pub. No.: US 2026/0136263 A1
(43) Pub. Date: May 14, 2026

(54) METHOD AND APPARATUS FOR USE IN MANAGING CONDITIONAL HANDOVER IN A SIDELINK RELAY NETWORK

(71) Applicant: CANON KABUSHIKI KAISHA, Tokyo (JP)

(72) Inventors: Pascal LAGRANGE, La Chapelle des Fougeretz (FR); Romain GUIGNARD, Rennes (FR)

(21) Appl. No.: 19/118,547

(22) PCT Filed: Oct. 3, 2023
(86) PCT No.: PCT/EP2023/077362

§ 371 Date: Apr. 4, 2025

(30) Foreign Application Priority Data
Oct. 5, 2022 (GB) 2214637.7

(51) Int. Cl. H04W 36/36; H04W 72/25

(52) U.S. Cl. CPC H04W 36/362; H04W 72/25

(57) ABSTRACT

Method and apparatus for use in managing conditional handover, CHO, of a relay user equipment, UE, from a source base station to a target base station, the relay UE serving one or more remote UEs via one or more sidelink connections, are disclosed. A method at the relay UE comprises sending, to the one or more remote UEs, a CHO notification indicating the relay UE has been configured to perform CHO. A method at one of the one or more remote UEs comprises receiving, from the relay UE, CHO notification indicating that the relay UE has been configured to perform CHO. The CHO notification may further indicate that the relay UE is to perform CHO. Alternatively, another CHO notification may be sent to the one or more remote UEs/received at one of the one or more remote UEs, with the another CHO notification indicating that the relay UE is to perform CHO.

### CROSS-REFERENCE TO RELATED APPLICATIONS

The application is the National Phase application of PCT Application No. PCT/EP2023/077362, filed on Oct. 3, 2023 and titled “Method and Apparatus for Use in Managing Conditional Handover in a Sidelink Relay Network”. This application claims the benefit under 35 U.S.C. § 119(a)-(d) of United Kingdom Patent Application No. 2214637.7, filed on Oct. 5, 2022 and titled “Method and Apparatus for Use in Managing Conditional Handover in a Sidelink Relay Network”. Each of the above cited patent applications are incorporated herein by reference in its entirety.

### FIELD OF THE INVENTION

The present invention generally relates to managing conditional handover in a sidelink relay network of a wireless communication system. More particularly, the present invention relates to managing the handover of a Relay UE and its served Remote UE(s) in a cellular Sidelink relay-based network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP®) standards, such as fourth-generation (4G) Long Term Evolution (LTE) or recent fifth-generation (5G) New Radio (NR) systems, or systems based on IEEE 802.11 standards, such as WiFi.

In order to support new vehicle-to-anything (V2X) scenarios in the context of road safety services, 3GPP introduced NR sidelink (SL) communications, or PC5 communications, in 3GPP Release 16. The purpose of such technology was to provide support for broadcast, groupcast and unicast communications between any two User Equipments (UEs) in both out-of-coverage and in-network coverage scenarios.

Based on the NR sidelink technology, 3GPP introduced the sidelink-based relaying functionality as part of the 3GPP Release 17 framework, where a relay UE may provide User Plane (UP) and Control Plane (CP) data relaying between a set of served remote UEs and the network (UE-to-network, or U2N, relay) or between a source remote UE, or source UE, and a target remote UE, or target UE (UE-to-UE, or U2U relay).

The purpose of the Release 17 sidelink relaying functionality was to both extend sidelink/network coverage and improve power efficiency, while considering a wider range of applications and services, including V2X, Public Safety and commercial applications and services. Some of these new V2X scenarios require ultra-reliability and low latency (URLLC) performance, in order to meet high-speed and high-density constraints, while requiring some network coverage extension, which may be achieved through sidelink relaying.

This first version of the sidelink relaying functionality, as defined in the Release 17 specification, mainly aimed at supporting the UE-to-network (U2N) relay while setting the foundations for the UE-to-UE (U2U) relay, to be further studied in 3GPP Release 18.

Along with the support of the new Release 18 UE-to-UE (U2U) relay use cases, 3GPP is also considering further enhancements to the existing Release 17 Sidelink Relay specification, which aim at ensuring service continuity, by allowing flexible inter/intra-base station (for 5G NR the base station is referred to as a gNB) path switching, while improving reliability/robustness and throughput, with the support of multi-path with relay.

Ensuring service continuity in a 3GPP network based on sidelink relay raises the issue of managing the handover of a relay UE, along with the one or more remote UEs it is serving, from a source gNB to a target gNB. In this respect, based on measurement reports issued by a relay UE over its Uu radio link with a source base station, or source gNB, this source gNB may identify the need for configuring a conditional handover (CHO) at this relay UE.

However, some remote UEs, initially served by the relay UE, may not wish to remain connected to this relay UE in case it actually performs a conditional handover (CHO). For instance, a static remote UE having good connectivity with some other relay-capable UE(s) or with a nearby base station may prefer performing relay reselection or connect directly to another base station instead of remaining connected to a relay UE that has been configured to perform conditional handover (CHO).

On the other hand, a remote UE having strong applicative interaction (e.g. close application interaction) with the relay UE it is served by (e.g. the remote UE may be a smart watch while the relay UE may be a smart phone) may wish to remain connected to this relay UE, regardless of it being configured to perform conditional handover (CHO).

Therefore, some new mechanisms are required to facilitate the handover of all or part of the remote UEs served by a relay UE that is to perform a conditional handover, whilst addressing the aforementioned issues.

### SUMMARY

In accordance with a first aspect of the present invention, there is provided a method for use in managing conditional handover, CHO, of a relay user equipment, UE, from a source base station to a target base station, the relay UE serving one or more remote UEs via one or more sidelink connections, the method at the relay UE comprising:
sending, to the one or more remote UEs, a CHO notification indicating the relay UE has been configured.

By providing CHO notification indicating the relay UE has been configured to perform CHO, the remote UE(s) are provided with information enabling each remote UE(s) to decide whether to stay connected to the relay UE or to detach from the relay UE. This helps to ensure that, if possible, the remote UE(s) that should stay connected to the relay UE upon CHO of the relay UE can stay connected and that other remote UE(s) can make a decision as to whether to be handed over or not rather than being automatically handed over to a new target cell when the relay UE performs CHO to the target base station controlling the new target cell. The decision or determination by the remote UE can be based on the CHO notification indicating that the relay UE has been configured to perform CHO. This may provide some time for a remote UE to discover other potential relay UEs and perform cell reselection prior to the actual relay UE handover, hence improving the service continuity at the remote UE. The remote UE may decide that the remote UE will perform relay reselection in response to a CHO notification irrespective of whether the relay UE provides information about the target cell or candidate target cells.

The CHO notification may include at least one of: relay CHO configuration notification information for indicating the relay UE has received one or more CHO configurations for one or more CHO candidate target cells; target cell information associated with one or more CHO candidate target cells with which the relay UE has been configured to perform CHO. The CHO notification may further include detach request information for requesting at least one of the one or more remote UEs detaches from the relay UE.

In an example, the target cell information includes for each CHO candidate target cell of the one or more CHO candidate target cells an identifier of the candidate target cell and/or an identifier of a target base station controlling the candidate target cell. The target cell information may further include probability information for indicating the probability of the relay UE performing CHO for the one or more CHO candidate target cells.

When the CHO notification includes additional information e.g. information associated with the target cell and/or information associated with one or more candidate or potential target cells, the remote UE(s) has additional information with which to make a decision as to whether the remote UE(s) wants to stay connected to the relay UE when the relay UE performs CHO to a target cell. For example, a remote UE can use the additional information to determine whether the target cell or candidate target cells are suitable for the remote UE to connect to. The remote UE may want to stay connected to the relay UE if CHO is performed to only one or some of the candidate target cells and to detach for the other candidate target cells.

The method may further comprise receiving from at least one of the one or more remote UEs remote UE CHO information indicating whether the at least one of the one or more remote UEs would remain connected to the relay UE after the relay UE performs CHO.

The remote UE CHO information may indicate for the at least one of the one or more candidate target cells whether the at least one of the one or more remote UEs would remain connected to the relay UE after the relay UE performs CHO to a respective candidate target cell.

Through receiving the remote UE CHO information, the relay UE is provided with the knowledge of the remote UEs that are likely to remain connected to the relay UE in case the relay UE performs a conditional handover (CHO). This facilitates smooth handover management of such remote UEs handover (HO) upon CHO of the relay UE.

The relay UE may send, to the source base station, remote UE information which may comprise at least one of: list of remote UEs information for indicating at least one of the number and the identifiers of the one or more remote UEs that would remain connected to the relay UE after the relay UE performs CHO; list of bounded remote UEs information for indicating at least one of the number and the identifiers of the remote UEs having a certain relationship with the relay UE; CHO connected remote UE requirement information for indicating communication requirements for the one or more remote UEs that would remain connected to the relay UE after the relay UE performs CHO.

Through sending the remote UE information, the source base station is provided with the knowledge of the remote UEs that are likely to remain connected to the relay UE in case the relay UE performs a conditional handover (CHO). This also helps to ensure smooth handover management of such remote UEs handover (HO) upon CHO of the relay UE.

In an example, the method further comprises sending another CHO notification indicating the relay UE is to perform CHO: for example, the another CHO notification indicating the relay UE is to perform CHO is a second CHO notification sent subsequent to the CHO notification indicating the relay UE has been configured to perform CHO which is a first CHO notification. The another CHO notification may be sent when certain handover execution conditions for CHO are met for at least one of the one or more CHO candidate target cells. In such a case, the another CHO notification indicates the relay UE is to perform CHO to a target cell for which the certain handover execution conditions for CHO are met. Each served remote UE can then decide (e.g. based on the information received from the relay UE in the CHO notification) whether it should remain connected to the relay UE or whether it should detach from relay UE either upon or shortly after receiving the first CHO notification or once the relay UE actually performs (or executes) CHO (i.e. in response to receiving the another or second CHO notification indicating the relay UE is to perform CHO).

In another example, the sending of the CHO notification comprises sending the CHO notification indicating the relay UE has been configured to perform CHO and is to perform CHO. For example, rather than sending two separate CHO notifications, only one CHO notification is sent indicating the relay UE has been configured to perform CHO and is to perform CHO. The CHO notification may be sent when certain handover execution conditions for CHO are met for a target cells. In such a case, the CHO notification indicates the relay UE is to perform CHO to a target cell for which the certain handover execution conditions for CHO are met. Each served remote UE can then decide (e.g. based on the information received from the relay UE in the CHO notification) whether it should remain connected to the relay UE or whether it should detach from relay UE upon or shortly after receiving the CHO notification indicating the relay UE is to perform CHO.

A remote UE that decides to detach from its relay UE may further consider to perform relay reselection or try to establish a direct connection to the source base station or to another base station in proximity.

In accordance with a second aspect of the present invention, there is provided a method performed at a remote UE being served by a relay UE via one or more sidelink connections. The method comprises receiving, from the relay UE, CHO notification indicating that the relay UE has been configured to perform CHO.

In accordance with a third aspect of the present invention, there is provided an apparatus for a User Equipment, UE, the apparatus comprising one or more processing units configured to, in a case where the UE is operating as a relay UE serving one or more remote UEs (e.g. via one or more sidelink connections): send, to the one or more remote UEs, a CHO notification indicating the relay UE has been configured to perform CHO.

In accordance with a fourth aspect of the present invention, there is provided an apparatus for a User Equipment, UE, the apparatus comprising one or more processing units configured to, in a case where the UE is operating as a remote UE served by a relay UE (for example, via one or more sidelink connections): receive, from the relay UE, a CHO notification indicating the relay UE has been configured to perform CHO.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIG. 2a is a schematic diagram illustrating user plane stacks of some protocol layers involved in Sidelink relay operations for UE-to-network (U2N) based relaying;

FIG. 2b is a schematic diagram illustrating user plane stacks of some protocol layers involved in Sidelink relay operations for UE-to-UE (U2U) based relaying;

FIGS. 3a and 3b are schematic and simplified diagrams illustrating some example message flows for managing remote UE handover (HO) upon relay UE conditional handover (CHO) according to embodiments of the invention;

FIG. 4 is a flow diagram of examples of operations at a relay UE for managing remote UE handover (HO) upon relay UE conditional handover (CHO) according to some embodiments of the invention;

FIG. 5 is a flow diagram of examples of operations at remote UE for managing remote UE handover (HO) upon relay UE conditional handover (CHO) according to some embodiments of the invention;

FIG. 6 is a block schematic diagram of an example wireless communication device in accordance with embodiments of the present invention;

FIG. 7 is a flowchart of a method performed at a relay UE in accordance with one or more embodiments of the present invention;

FIG. 8 is a flowchart of a method performed at a remote UE in accordance with one or more embodiments of the present invention.

### DETAILED DESCRIPTION

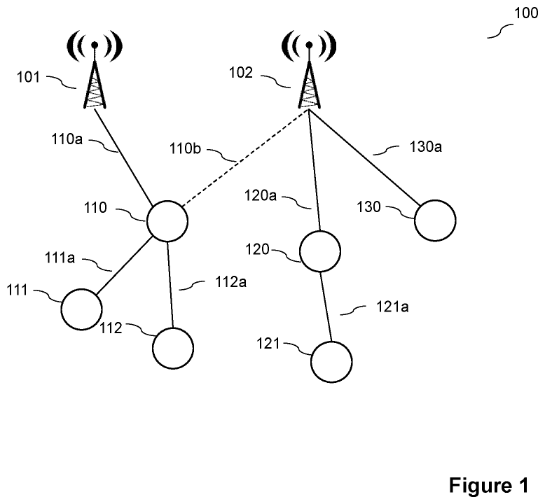

FIG. 1 represents an example of a wireless communication system 100 capable of supporting Sidelink Relay and shows a sidelink relay arrangement or system (or network) including plurality of nodes including a plurality of relay User Equipment (UE) serving one or more remote User Equipment (UE).

For instance, in FIG. 1, UE node 110 is served by network node 101 and may operate as a relay UE node relaying data between one of the UE nodes 111, 112 (referred to as remote UE nodes) and the network node, 101, hence performing UE-to-network (U2N) relay. In an example where the network node 101 is part of a cellular network, the relay UE 110 is served by a cell controlled by the network node 101.

UE node 120 is served by network node 102 and may also operate as a UE-to-network (U2N) relay UE node (for example, relaying data between the remote UE 121 and the network node 102).

UE node 130 is also served by network node 102 and may have some relaying capability, i.e. UE node 130 may act as a UE-to-network (U2N) relay UE node at some time, even though it is not serving any remote UE at the time represented in FIG. 1.

The network nodes 101 and 102 may be base stations of a wireless network, such as a fifth-generation (5G) New Radio (NR) network or a Long Term Evolution (LTE) network. FIG. 1 only shows the base stations of the wireless network for clarity. For a 5G NR network, the network node 101, or 102, is referred to as a gNB.

Even though sidelink relay is most likely to be considered in the context of V2X networks, it is not intended that the invention is limited to UE nodes that are in or part of a vehicle. Each of the UE nodes (relay or remote) may be a wireless communication device located in or part of a vehicle or a Road Side Unit (RSU) or a wireless communication device of a Vulnerable Road User (VRU) (e.g. a mobile or portable communication device (such as a smart phone, PDA, laptop, or similar devices) of a pedestrian or cyclist). In the following, a relay UE node will also be referred to as a relay UE, a remote UE node will also be referred to as a remote UE and a network node will be referred to as a gNB. Although in the following description, embodiments and examples of embodiments of the present invention will be described with respect to a 5G NR network, it will be appreciated that it is not intended that the present invention is limited to 5G NR systems and may be used in any wireless communication systems supporting sidelink (or peer to peer) relay communications.

In an example shown in FIG. 1, in a UE-to-Network (or U2N) scenario with the UE 110 (or UE 120) operating as UE-to-Network relay UE, the UE-to-Network relay UE 110 (or relay UE 120) connects the UEs 111 and 112 (or UE 121), operating as remote UEs, to the gNB 101 (or gNB 102). The remote UE 111 is connected to the relay UE 110 via or through a sidelink 111a which may be referred to as a PC5 hop or link or connection or interface 111a. Similarly, remote UE 112 and remote UE 121 have PC5 hops, or links or connections or interfaces 112a and 121a respectively with the relay UE 110 and relay U 120. A Uu hop or link or connection or interface 110a connects the relay UE 110 to the gNB 101, while a Uu hop or link or connection or interface 120a and 130a respectively connect the relay UE 120 and the UE 130 to the gNB 102. PC5 connections are used for the relayed traffic of the remote UEs (111, 112 and 121) and the non-relayed traffic specific to the relay UE 110, 120, i.e. for the direct communications between relay UE 110, 120 and the other remote UEs (111, 112 and 121). Therefore, the remote UE 111 is connected to the gNB 101 through the relay UE 110 with a PC5 hop 111a and a Uu hop 110a. For uplink communication, the remote UE 111 is the source node (or transmitter node for transmitting data) and the gNB 101 is the destination or target node (or receiver node for receiving data) for a sidelink relay connection established between the remote UE 111 and the gNB 101 with a PC5 hop 111a and a second Uu hop 110a and for downlink communication, the remote UE 111 is the destination or target node (or receiver node) and the gNB 101 is the source node (or transmitter node). Similarly, the remote UE 121 is connected to the gNB 102 through the relay UE 120 with a PC5 hop 121a and a Uu hop 120a.

At some point, the gNB 101, acting as a source gNB, may decide to hand over the relay UE 110 to the gNB 102, which would then act as a target gNB. For example, in the case where the radio conditions in the serving cell (not shown in FIG. 1) controlled by the source gNB 101 deteriorate such that the radio conditions in the target cell (not shown in FIG. 1) controlled by the target gNB 102 are better than the serving cell, the source gNB 101 may decide to handover the relay UE 110 to the target gNB 102. In such a case, the relay UE 110 would detach from the source gNB 101, thereby releasing the Uu link 110a to further connect to the target gNB 102 through the Uu link 110b (shown in dotted lines in FIG. 1) established as part of a re-establishment procedure.

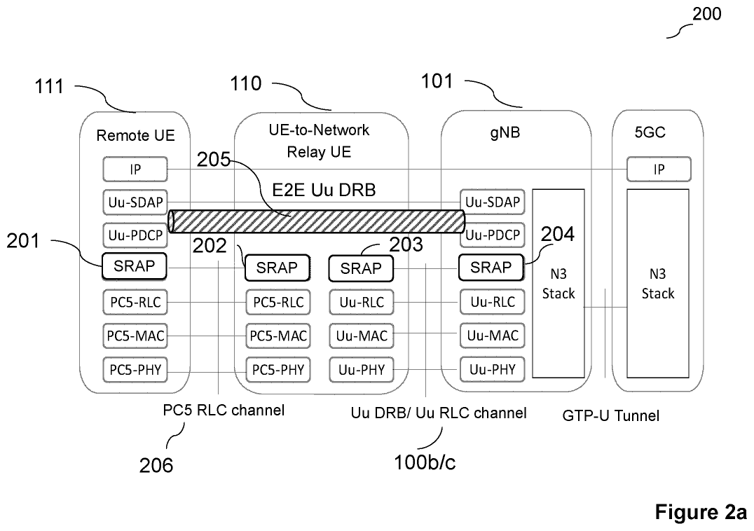

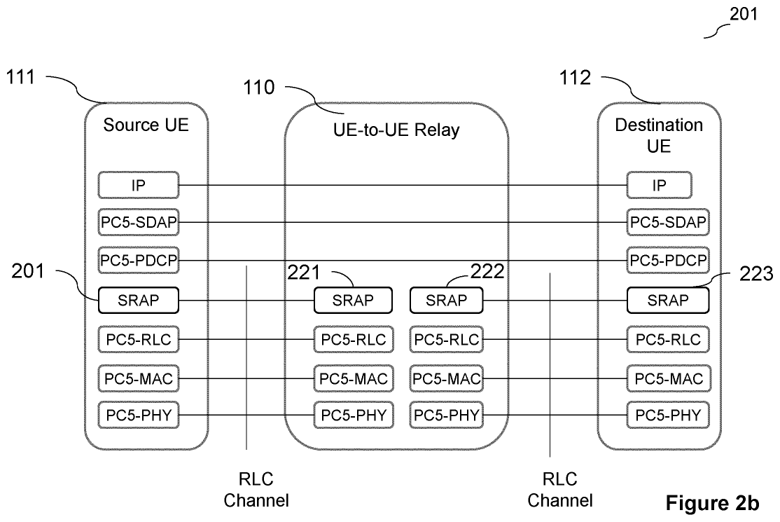

In order to set up a relayed traffic between a first node (remote UE) and a second node (gNB or remote UE), a Sidelink relay architecture may be used according to the 3GPP TR 38.836. The user plane architecture or protocol stack is shown in FIG. 2a and FIG. 2b and represents the Sidelink Relay adaptation layer called SRAP that is introduced between the PDCP layer and the RLC layer at the extreme nodes and above the RLC layer in the relay UE. This architecture was first documented in the TR 38.836 and finally refined in 3GPP TS 38.300 while the SRAP layer is defined in 3GPP TS 38.351.

This architecture shown in FIG. 2a shows the Sidelink relay architecture 200 for the UE-to-Network relay scenario. The architecture shown in FIG. 2b shows the Sidelink relay architecture 201 for the UE-to-UE relay scenario which, as shown in FIG. 2b, is similar to that shown in FIG. 2a. However, the relay UE in the UE-to-UE relay case has two PC5 SRAP entities or layers 221 and 222. As shown in FIG. 2a for the UE-to-Network relay scenario, the remote UE, such as remote UE 111, has a PC5 SRAP layer 201 between its Uu PDCP layer and it PC5 RLC layer.

As shown in FIG. 2a for the UE-to-Network relay scenario, at the relay UE, such as relay UE 110, there are two SRAP layers to interface with the PC5 hop 111a and the Uu hop 110a: the PC5 SRAP layer 202 is connected to the PC5 SRAP 201 of the remote UE 111 through the PC5 hop 111a; and the Uu SRAP layer or entity 203 is connected to the Uu SRAP layer 204 at the gNB side 101 through the Uu link 110a. A remote UE 111 establishes End-to-End radio bearers 205 with the gNB 101. These radio bearers could be a Signalling Radio Bearer SRB or Data Radio Bearer DRB. FIG. 2a shows an E2E Uu DRB between the remote UE 111 and the gNB 101 by way of example.

The PC5 SRAP layer 202 of the UE-to-Network relay UE 110 receives data or packets (traffic data or signalling) over or via ingress PC5 RLC channels 206 from remote UE 111 (at PC5 hop 111a) in an uplink direction and transmits the packets to the Uu SRAP entity 203 of the same relay UE 110.

The Uu SRAP 203 entity will map the corresponding ingress PC5 RLC channels 206 to egress Uu RLC channels 100b and/or 100c at Uu link 110a. Thus, a mapping table is required for uplink and it is configured by gNB 101 at the Uu SRAP entity 203 of the relay UE 110.

The mapping table takes at its input an identifier of the remote UE 111 (e.g. L2-ID), an identifier of the E2E radio bearer 205 (e.g. the E2E Uu DRB 205 ID) and an identifier of the ingress PC5 RLC channel (or bearer) 206 and identifies the egress Uu RLC bearer ID where the E2E radio bearers are mapped. For example, the UE E2E bearer ID and remote UE ID can be obtained from the header of a data packet received at the Uu SRAP entity 203. An example of an entry for an uplink mapping table with one entry configured at the Uu SRAP entity 203 is shown in Table 1 below. It will be appreciated that the mapping table will be configured so that it has an entry for each remote UE connected to the relay UE.

TABLE 1

| | | Ingress PC5 RLC | Egress Uu RLC |
|---|---|---|---|
| UE ID | E2E Uu DRB ID | channel ID | channel ID |
| x1 | y1 | z1 | w1 |

At the Uu side or link 110a, different radio bearers of the same remote UE or different remote UEs can be subject to N:1 mapping and data multiplexing over Uu RLC channels 100b and 100c.

In the downlink direction, data or packets transmitted from gNB 101 arrive at the relay UE 110 through the Uu link 110a. The ingress Uu RLC channels 100b and 100c at the Uu SRAP entity 203 of the relay UE 110 will be mapped to the egress PC5 RLC channels 206 at PC5 hop 111a. The corresponding packets in downlink will be transmitted from the Uu SRAP entity 203 to the PC5 SRAP entity 202 to be then transmitted through the PC5 RLC channels 206 to the remote UE 111. Thus, a mapping table is required for downlink and it is configured by the gNB 101 at Uu SRAP entity 203 of the relay UE 110. The mapping table requires at its input the remote UE 111 L2-ID, the End-to-End radio bearer 205 ID and the ingress Uu RLC channel (or bearer) 100b and 100c ID and delivers the egress PC5 RLC channels (or bearer) 206 ID to the PC5 SRAP entity 202 of the same relay UE 110. The End-to-End Radio bearer 205 is then mapped at the PC5 hop 111a to the egress PC5 RLC channels 206. For example, the UE E2E bearer ID and remote UE ID can be obtained from the header of a packet received at the Uu SRAP entity 203. An example of a downlink mapping table with one entry configured at the Uu SRAP entity 203 is shown in Table 2 below. It will be appreciated that the mapping table will be configured so that it has an entry for each remote UE connected to the relay UE.

TABLE 2

| | | Egress PC5 RLC | Ingress Uu RLC |
|---|---|---|---|
| UE ID | E2E Uu DRB ID | channel ID | channel ID |
| x2 | y2 | z2 | w2 |

As mentioned in 3GPP TS 38.351, each SRAP entity has a transmitting part and a receiving part. Across the PC5 interface 111a, the transmitting part of the PC5 SRAP entity 201 at the remote UE 111 has a corresponding receiving part at PC5 SRAP entity 202 at the UE-to-Network Relay UE 110, and vice-versa. Across the Uu interface 110a, the transmitting part of the Uu SRAP entity 203 at the UE-to-Network Relay UE 110 has a corresponding receiving part at Uu SRAP entity 204 at the gNB 101, and vice-versa.

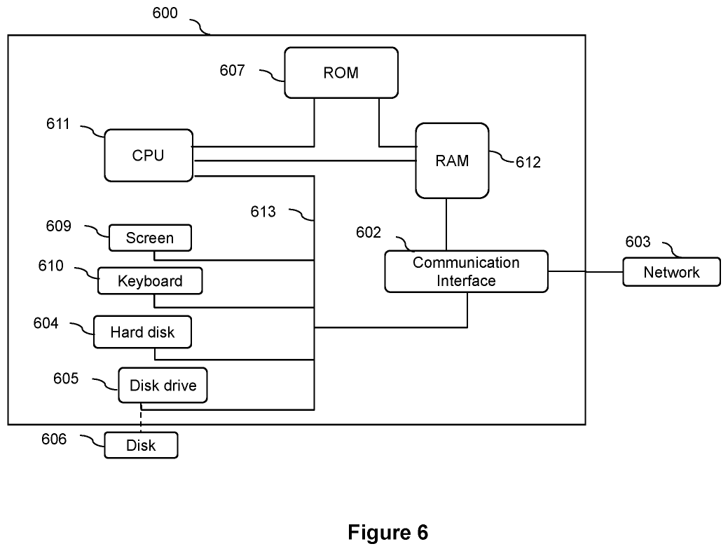

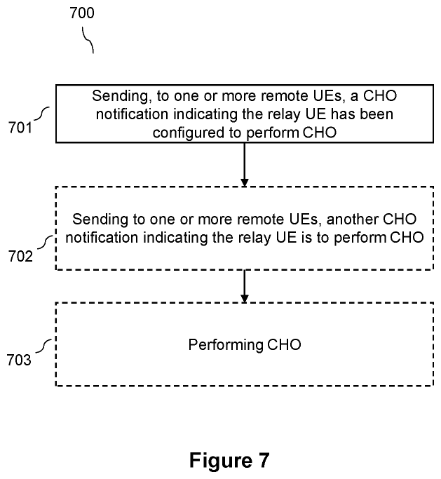

Referring now to FIG. 7 which is a flow chart showing steps of a method 700 performed at a relay UE. Method 700 is for use in managing conditional handover (CHO) of a relay UE, from the source base station (e.g. a network node) to a target base station, with the relay UE serving (or being wirelessly connected to) one or more remote UEs via one or more sidelink connections or sidelinks. The source and target base station support sidelink relaying and with the relay UE, are part of a sidelink relay network of a wireless communication system. The method also facilitates the management of handover of the one or more remote UEs served by the relay UE upon relay UE CHO. The wireless communication system may be, for example, the wireless communication system 100 of FIG. 1. With respect to the example shown in FIG. 1, the relay UE performing method 700 may be relay UE 110, the source base station may be source base station 101 (also referred to as source gNB 101), the target base station may be target base station 102 (also referred to as target gNB 102), and the one or more remote UEs may be remote UEs 111 and 112. The method 700 as shown in and described with respect to FIG. 7 may be performed by software elements and/or hardware elements. Thus, for example, the method as shown in and described with respect to FIG. 7 may be performed by an apparatus for the relay UE comprising one or more processing units configured to carry out the method. The relay UE may be implemented in a communication device 600 as shown in and described with reference to FIG. 6 with the method as shown in and described with respect to FIG. 7 being performed by one or more processing units, such as the central processing unit 611.

Briefly, at step 701, the relay UE 110 sends, to the remote UE(s) served by the relay UE 110, a CHO notification indicating the relay UE 110 has been configured to perform CHO.

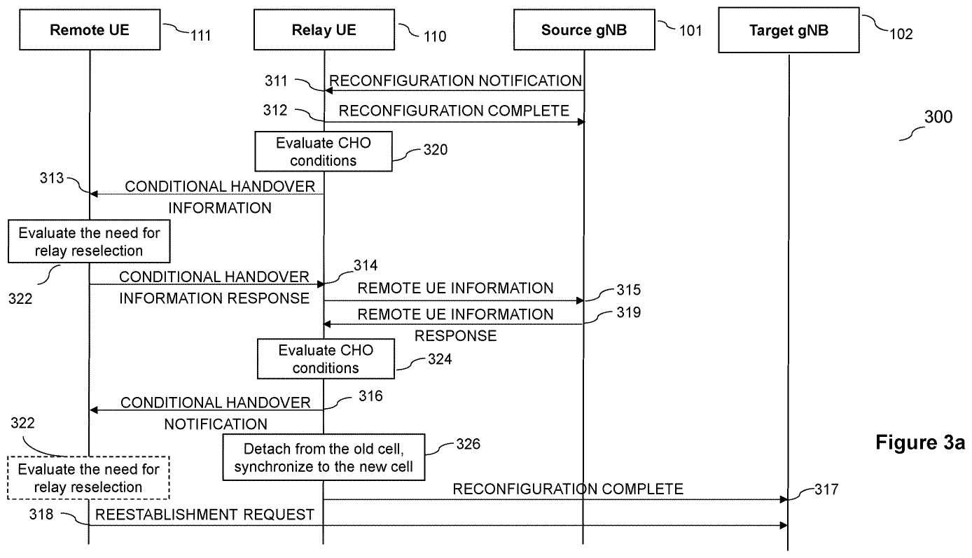

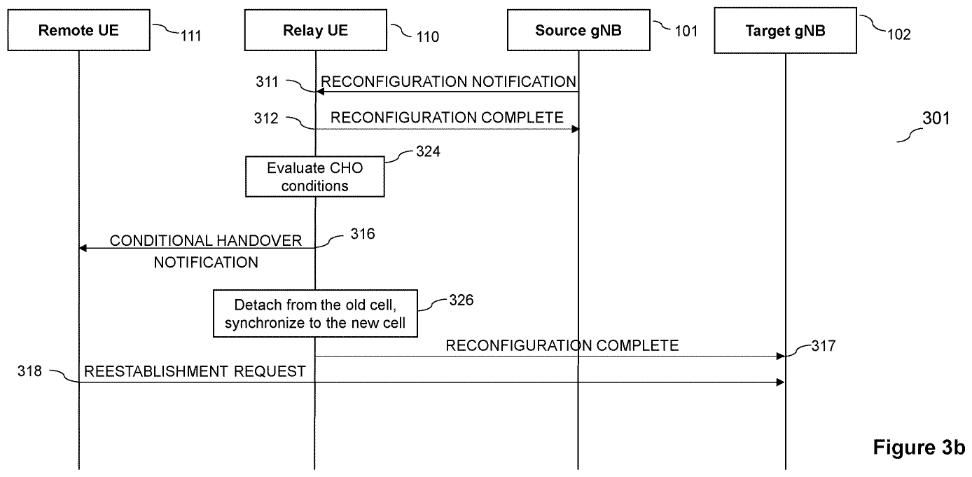

The CHO notification indicating the relay UE 110 has been configured to perform CHO may be a first CHO notification with another CHO notification (e.g. a second CHO notification) indicating the relay UE is to perform CHO to a target cell controlled by a target gNB 102 being sent subsequently (at step 702). This CHO notification and another CHO notification example is described below with reference to the example message flow of FIG. 3a. In this case, the CHO notification may be sent in a first message, such as CONDITIONAL HANDOVER NOTIFICATION message 313, and the another CHO notification may be sent in a second message, such as CONDITIONAL HANDOVER NOTIFICATION message 316 as discussed in more detail below.

In an alternative example, the CHO notification sent to the remote UE(s) at 701 indicates the relay UE 110 has been configured to perform CHO and also indicates that the relay UE is to perform CHO to a target cell controlled by a target gNB 102. This alternative CHO notification example is described below with reference to the example message flow of FIG. 3b. In this case, the CHO notification may be sent in one message, such as CONDITIONAL HANDOVER NOTIFICATION message 316 as discussed in more detail below.

In either case, by providing CHO notification indicating the relay UE 110 has been configured to perform CHO, the remote UE(s) are provided with information enabling each remote UE(s) to decide whether to stay connected to the relay UE 110 or to detach from the relay UE 110. This helps to ensure that the remote UE(s) that should stay connected to the relay UE on CHO can stay connected and that other remote UE(s) can make a decision as to whether to be handed over or not rather than being automatically handed over to a new gNB when the relay UE 110 performs CHO to the target gNB. The decision or determination by the remote UE can be based on a CHO notification indicating that the relay UE has been configured to perform CHO. The remote UE may decide that the remote UE will perform relay reselection in response to a CHO notification irrespective of whether the relay UE has information about the target cell or candidate target cells. As part of the determination, the remote UE 111 may consider whether the target cell or one or more candidate target cells are acceptable or suitable to serve the remote UE 111. When the CHO notification includes additional information e.g. information associated with the target cell when CHO is to be performed and/or information associated with one or more candidate or potential target cells, the remote UE(s) have additional information with which to make the decision. For example, a remote UE may want to stay connected to the relay UE 110 if CHO is performed to only one or some of the candidate target cells and to detach for the other candidate target cells. In this example, the remote UE may not detach until the remote UE receives a CHO notification indicating the target cell to which the relay UE is to perform CHO (and which is a target cell to which the remote UE does not want to remain connected).

At step 703, the relay UE may perform CHO to a target cell controlled by the target gNB 102 when certain handover execution conditions for CHO are met for the target cell. The remote UE(s) which are to remain connected to the relay UE may then initiate a re-establishment procedure to connect to the target gNB 102.

In an example, the CHO notification includes at least one of: relay CHO configuration notification information for indicating the relay UE has received one or more CHO configurations for one or more CHO candidate target cells (e.g. Relay CHO configuration notification information as discussed below with respect to the CONDITIONAL HANDOVER NOTIFICATION message 313); and target cell information associated with one or more CHO candidate target cells with which the relay UE has been configured to perform CHO. The target cell information may include for each CHO candidate target cell of the one or more CHO candidate target cells an identifier of the candidate target cell and/or an identifier of a target base station controlling the candidate target cell (e.g. NR Cell Global Identity (NCGI), NR Cell ID (NCI), target Cell ID (CI)). The target cell information may further include probability information for indicating the probability of the relay UE performing CHO for the one or more CHO candidate target cells. For example, the target cell information includes for each CHO candidate target cell of the one or more CHO candidate target cells probability information for indicating the probability of the relay UE performing CHO for the CHO candidate target cell compared to other CHO candidate target cells. In another example, the target cell information includes probability information for indicating the CHO candidate target cell which is the most probable (or likely) for selection as the target cell. The target cell information may include the Relay CHO configuration information as discussed below with reference to the CONDITIONAL HANDOVER NOTIFICATION message 313.

The CHO notification may further include detach request information for requesting at least one of the remote UE(s) detaches from the relay UE. The detach request information may include the Detach Request information as discussed below with reference to the CONDITIONAL HANDOVER NOTIFICATION message 313.

The relay UE 110 may receive, from at least one of the remote UE(s), remote UE CHO information indicating whether the at least one of the one or more remote UEs would remain connected to the relay UE after the relay UE performs CHO. The relay UE 110 may receive the remote UE CHO information in response to a request sent by the relay UE 110 (e.g. the request may be included in the CHO notification). The remote UE CHO information sent by the remote UE may indicate to the relay UE 110 its intention to remain connected or not to the relay UE 110 in case the relay UE actually performs a CHO, regardless of the target cell considered for this conditional handover (CHO). In the case where the remote UE(s) have been notified that the relay UE 110 has been configured with one or more candidate target cells, the remote UE CHO information indicates for at least one of the one or more candidate target cells (or for each of the one or more candidate target cells), whether the remote UE(s) would (or want to) remain connected to relay UE after/when the relay UE performs CHO to the respective candidate target cell. In an example, the remote UE CHO information includes at least one of: connection identification information associated with each of the one or more candidate target cells for which the at least one remote UE would remain connected to the relay UE after the relay UE performs CHO, such as the CHO Connection information discussed below with reference to the CONDITIONAL HANDOVER INFORMATION RESPONSE message 314; detach identification information associated with each of the one or more candidate target cells for which the at least one remote UE would not remain connected to the relay UE after the relay UE performs CHO, such as the CHO Detach information discussed below with reference to the CONDITIONAL HANDOVER INFORMATION RESPONSE message 314.

In an example discussed above where the relay UE 110 sends a CHO notification in a first message, such as CONDITIONAL HANDOVER NOTIFICATION message 313, and another CHO notification is sent in a second message, such as CONDITIONAL HANDOVER NOTIFICATION message 316 (e.g. as described with respect to the example message flow of FIG. 3a), the another CHO notification may be sent when the relay UE 110 determines that certain handover execution conditions for CHO are met for at least one of the one or more CHO candidate target cells and the another CHO notification indicates the relay UE is to perform CHO to a target cell, which is one of the one more candidate target cells, for which the certain handover execution conditions for CHO are met as discussed in more detail below. The another CHO notification includes at least one of: relay CHO notification information for indicating that the relay UE is to perform CHO to a target cell, such as Relay CHO notification information of CONDITIONAL HANDOVER NOTIFICATION message 316; target cell information associated with the target cell with which the relay UE is to perform CHO, such as Relay CHO configuration information. The another CHO notification may further include detach request information for requesting at least one of the one or more remote UEs detaches from the relay UE, such as the Detach Request information as discussed below. The determination that certain handover execution conditions for CHO are met may be made by the relay UE 110 as discussed below with respect to step 320 and 324.

In the case where the relay UE 110 determines that the handover execution conditions for CHO are met for two or more of the candidate target cells, the relay UE 110 selects one of the two or more of the candidate target cells as the target cell for performing CHO. When there is more than one candidate target cell for which the handover execution conditions for CHO are met, the relay UE 110 may make a selection based on one or more of: channel quality provided each of the more than one candidate target cell; priority indication from the source gNB 101; number of remote UEs that would stay connected to each of the more than one candidate target cell (e.g. select the candidate target cell with the highest number of remote UEs that would stay connected).

In an example discussed above where the relay UE 110 sends a CHO notification indicating the relay UE 110 has been configured to perform CHO and also indicating that the relay UE is to perform CHO to a target cell controlled by a target gNB 102 (e.g. as described with respect to the example message flow of FIG. 3b), the relay UE 110 provides such a message when the relay UE 110 determines that certain handover execution conditions for CHO are met for at least one of the one or more CHO candidate target cells. When the handover execution conditions for CHO are met for two or more of the candidate target cells, the relay UE 110 selects one of the two or more of the candidate target cells as the target cell for performing CHO as discussed above. The CHO notification includes at least one of: relay CHO notification information for indicating that the relay UE is to perform CHO to a target cell, such as Relay CHO notification information of CONDITIONAL HANDOVER NOTIFICATION message 316; target cell information associated with the target cell with which the relay UE is to perform CHO, such as Relay CHO configuration information.

The relay UE 110 may receive from the source gNB 101 CHO configuration information for configuring the relay UE to perform CHO. The CHO configuration information may include for each of one or more CHO candidate or potential target cells: configuration of a CHO candidate target cell to be used by the relay UE to access the CHO candidate target cell; one or more CHO execution conditions to be met before handover to the CHO candidate target cell can be performed. More details of CHO configuration information are provided below. For example, the CHO configuration information may be included in a RECONFIGURATION NOTIFICATION message 311 as described below with reference to FIG. 3a.

The relay UE 110 may send, to the source gNB 101, remote UE information and may receive, from the source gNB 101, handover status information. For example, the relay UE 110 may send remote UE information in a message such as REMOTE UE INFORMATION message 315 as described below with reference to FIG. 3a. The relay LIE 110 may receive handover status information (e.g. Handover Granted List information) in a message such as REMOTE UE INFORMATION RESPONSE message 319 as described below with reference to FIG. 3a. Although not shown in FIG. 3b, such messages 315 and 319 may also be exchanged in the example message flow of FIG. 3b: for example, before sending the CHO notification in message 316.

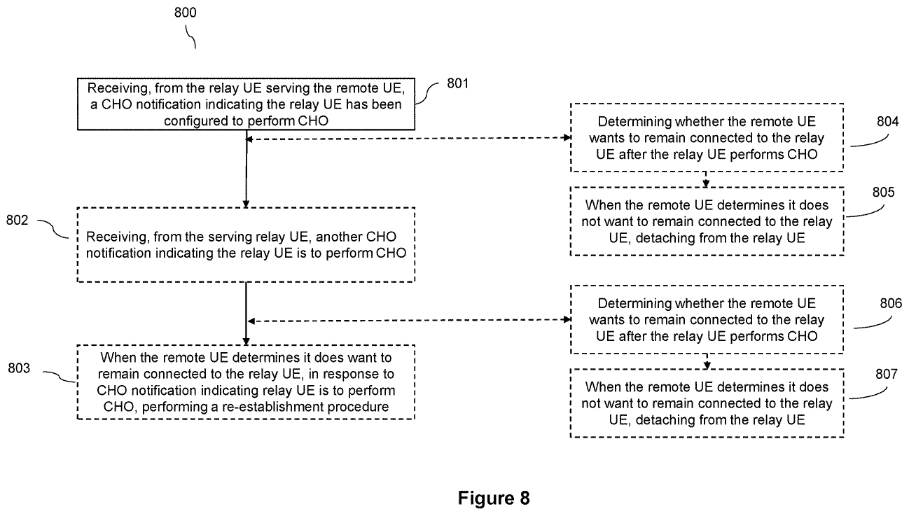

Referring now also to FIG. 8 which is a flow chart showing steps of a method 800 performed at a remote LIE. Method 800 is for use in managing conditional handover (CHO) of a relay UE, from a source base station (e.g. a network node) to the target base station, with the relay LIE serving (or being wirelessly connected to) one or more remote UEs via one or more sidelink connections or sidelinks. The source and target base station support sidelink relaying and with the relay UE, are part of a sidelink relay network of a wireless communication system. The method also facilitates the management of handover of the one or more remote UEs served by the relay LIE upon relay LIE CHO. The wireless communication system may be, for example, the wireless communication system 100 of FIG. 1. With respect to the example shown in FIG. 1, the remote LIE performing method 800 may be remote LIE 111, the target base station may be base station 102 (also referred to as target gNB 102), the source base station may be source base station 102 (also referred to as source gNB 101), the relay UE may be relay LIE 110. The method 800 as shown in and described with respect to FIG. 8 may be performed by software elements and/or hardware elements. Thus, for example, the method as shown in and described with respect to FIG. 8 may be performed by an apparatus for the remote UE comprising one or more processing units configured to carry out the method. The remote UE may be implemented in a communication device 600 as shown in and described with reference to FIG. 6 with the method as shown in and described with respect to FIG. 8 being performed by one or more processing units, such as the central processing unit 611.

Briefly, at step 801, the remote UE 111 receives, from the relay UE 110, CHO notification indicating the relay UE 110 has been configured to perform CHO.

The CHO notification indicating the relay UE 110 has been configured to perform CHO may be a first CHO notification with another CHO notification (e.g. a second CHO notification) indicating the relay UE is to perform CHO to a target cell controlled by a target gNB 102 being received subsequently (at step 802). This CHO notification and another CHO notification example is described below with reference to the example message flow of FIG. 3a. In this case, the CHO notification may be received in a first message, such as CONDITIONAL HANDOVER NOTIFICATION message 313, and the another CHO notification may be received in a second message, such as CONDITIONAL HANDOVER NOTIFICATION message 316 as discussed in more detail below.

In an alternative example, the CHO notification received at the remote UE at 801 indicates the relay UE 110 has been configured to perform CHO and also indicates that the relay UE is to perform CHO to a target cell controlled by a target gNB 102. This alternative CHO notification example is described below with reference to the example message flow of FIG. 3b. In this case, the CHO notification may be sent in one message, such as CONDITIONAL HANDOVER NOTIFICATION message 316 as discussed in more detail below

In either case, by providing CHO notification indicating the relay UE 110 has been configured to perform CHO, the remote UE is provided with information enabling the remote UE to determine whether or not the remote UE wants to remain connected to the relay UE 110 after the relay UE performs CHO. This helps to ensure that the remote UE(s) that should stay connected to the relay UE on CHO can stay connected and that other remote UE(s) can make a decision as to whether to be handed over or not rather than being automatically handed over to a new gNB when the relay UE 110 performs CHO to the target gNB. The decision or determination by the remote UE can be based on a CHO notification indicating that the relay UE has been configured to perform CHO (e.g. step 804 is performed after step 801). For example, the remote UE may decide that the remote UE will perform relay reselection in response to a CHO notification irrespective of whether the relay UE has information about the target cell or candidate target cells. In the case where another CHO notification is received at step 802, the decision or determination by the remote UE can alternatively or additionally be performed based on the another CHO notification received: e.g. a determining step 804 can be performed after step 801 and/or a determining step 806 can be performed after step 802. In the case where the CHO notification received at step 801 indicates the relay UE 110 has been configured to perform CHO and also indicates that the relay UE is to perform CHO, the decision or determination by the remote UE can be based on a CHO notification received at step 801: e.g. step 804 is performed after step 801—there is no steps 802, 806, 807 in this case.

As part of the determination of whether or not the remote UE wants to or would remain connected to the relay UE 110 after the relay UE performs CHO (e.g. at steps 804 and 806), the remote UE 111 may consider whether the target cell or one or more candidate target cells are acceptable or suitable to serve the remote UE 111. If suitable, the remote UE 111 may decide that it would or wants to remain connected after the relay UE 110 performs CHO. If not suitable, the remote UE 111 may decide that it would not or does not want to remain connected and so will detach from the relay UE. For example, in the case the remote UE is a static node, the remote UE may determine that the target cell the relay UE is to move to or may move to is not suitable for a static node and in such a case, may then decide to detach from the relay UE 110 (either when notified that the relay UE 110 is configured for CHO (e.g. at step 805) or when notified that the relay UE 110 is to perform CHO to the target cell (e.g. at step 807). More details of how the determination or evaluation may be performed by the remote UE 111 at steps 804 and 807 is discussed below with reference to step 322 of FIG. 3a.

When the CHO notification includes additional information e.g. information associated with the target cell when CHO is to be performed and/or information associated with one or more candidate or potential target cells, the remote UE has additional information with which to make the decision. For example, a remote UE may want to stay connected to the relay UE 110 if CHO is performed to only one or some of the candidate target cells and to detach for the other candidate target cells. In this example, the remote UE may not detach (even if it decides it does not want to stay connected after step 801) until the remote UE receives a CHO notification indicating the relay UE is to perform CHO to the target cell CHO (and which is a target cell to which the remote UE does not want to remain connected) as discussed in more detail below.

When the remote UE 111 decides that it does not want to remain connected to the relay UE 110, the remote UE 111 may detach from the relay UE 110 either on receipt of the CHO notification indicating the relay UE 110 is configured for CHO (e.g. step 805 is performed after step 801) or on receipt of the CHO notification indicating the relay UE 110 is to perform CHO (e.g. step 807 is performed after step 802). Once the remote UE 111 decides to detach from its relay UE 110, the remote UE 111 may further consider to perform relay reselection or try to establish a direct connection to the source gNB 101 or to another gNB in proximity (e.g. direct connection to gNB 102).

When the remote UE 111 decides that it does want to remain connected to the relay UE 110 and when the relay UE 110 performs or is to perform CHO to a target gNB (e.g. in response to a notification that the relay UE 110 is to perform CHO), the remote UE 111 performs, at step 803, a re-establishment procedure with the target gNB 102. For example, the re-establishment procedure is a RRC re-establishment procedure in which case the remote UE 111 sends a REESTABLISHMENT REQUEST message (such as REESTABLISHMENT REQUEST message 318 as discussed below) to the target gNB 102.

The messages sent by the relay UE 110 to a remote UE and the messages received by the relay UE 110 from the remote UE as described above with reference to FIG. 7 correspond to messages received at the remote UE 111 from the relay UE 110 and messages sent by the remote UE 111 to the relay UE 110 and thus, the above description for such messages can be applied to messages received at and sent by the remote UE 111 and the details will not be repeated here.

More details regarding messages sent/received by the relay UE 110 and the remote UE(s) are given below in the description with reference to FIGS. 3a, 3b, 4-5.

FIGS. 3a and 3b illustrate some example message flows for managing Remote UE handover (HO) upon Relay UE conditional handover (CHO) according to embodiments of the invention. The message flows are described with reference to the wireless communication system of FIG. 1 where a Relay UE is UE 110 serving Remote UE 111. The Relay UE 110 is served by a cell controlled by gNB 101, which is referred to as the source gNB 101, and a neighbouring cell is controlled by gNB 102 which is a target gNB 102 (or a candidate target gNB) for the Relay UE 110.

A Conditional Handover (CHO) is defined in 3GPP TS 38.300 v17.1.0 (e.g. clause 9.2.3.4) as a handover that is executed by the UE when one or more handover execution conditions are met. Clause 9.2.3.4.1 of 3GPP TS 38.300 v17.1.0 states an execution condition may consist of one or two trigger condition(s) (CHO events A3/A5, as defined in 3GPP TS 38.331). Only single RS type is supported and at most two different trigger quantities (e.g. Received Signal Reference Power (RSRP) and Received Signal Reference Quality (RSRQ), RSRP and Signal to Interference Noise Ratio (SINR), etc.) can be configured simultaneously for the evaluation of CHO execution condition of a single candidate cell.

For CHO at a UE, which in the cases described herein is a relay UE, the relay UE is configured by the relay UE's current source gNB (which is controlling the relay UE's current serving cell) with CHO configuration information. The source gNB uses measurement reports provided by the relay UE to determine CHO candidate target cells and sends handover request messages to the identified CHO candidate target cells asking the target gNBs serving the CHO candidate target cells to accept the handover request and to provide configurations to be used by the relay UE to access the corresponding target cells. The source gNB sends, to the relay UE, CHO configuration information (e.g. in the RECONFIGURATION NOTIFICATION message 311 as described below). The CHO configuration information includes the configuration of the CHO candidate cell generated by a candidate target gNB and one or more CHO execution conditions to be met before handover to the candidate target cell can be performed or executed by the relay UE, which execution conditions are generated by the source gNB. There may be more than one CHO candidate target cell for the relay UE and if there is more than one candidate target cell for the relay UE, CHO configuration information provided to the relay UE includes CHO configuration information (e.g. configuration of the CHO candidate target cell and one or more execution conditions) for each CHO candidate target cell. The CHO configuration information is stored at the relay UE. The relay UE starts evaluating the execution condition(s) upon receiving the CHO configuration, and stops evaluating the execution condition(s) once a handover is executed.

In this respect and referring first to the example message flow shown in FIG. 3a, the source gNB 101 may send to the Relay UE 110 a RECONFIGURATION NOTIFICATION message 311 containing the configuration of CHO candidate cell(s) and CHO execution condition(s).

In one example, the RECONFIGURATION NOTIFICATION message 311 is the RRCReconfiguration message defined in TS 38.331 v17.1.0.

The Relay UE 110 may acknowledge the reception of the CHO configuration by sending to the source gNB 101 a RECONFIGURATION COMPLETE message 312.

In one example, the RECONFIGURATION COMPLETE message 312 is the RRCReconfigurationComplete message defined in TS 38.331 v17.1.0.

After receiving CHO configuration in the RECONFIGURATION NOTIFICATION message 311, the Relay UE 110 may maintain the connection with the source gNB 101 and, along with starting evaluating the CHO execution conditions for the candidate cell(s) (at 320), the Relay UE 110 may inform the Remote UE 111 that it has received from the source gNB 101 some CHO configuration by sending a CONDITIONAL HANDOVER INFORMATION message 313. For example, the Relay UE 110 may send to the Remote UE 111 a CHO notification (e.g. in the CONDITIONAL HANDOVER INFORMATION message 313) indicating that the Relay UE 110 has received CHO configuration and so has been configured to perform CHO. When the Relay UE 110 serves more than one Remote UE, the Relay UE 110 sends CHO configuration notification information to each of the served Remote UEs.

By notifying the served Remote UE(s) that the Relay UE 110 has been configured for CHO, the Relay UE 110 may allow its served Remote UE(s) to decide (e.g. based on the CHO configuration information received from the Relay UE 110) whether it should remain connected to the Relay UE 110 or whether it should detach from Relay UE 110, either now (i.e. on receipt of the CHO notification or shortly thereafter) or once the Relay UE 110 actually performs (or executes) CHO. A Remote UE that decides to detach from its Relay UE 110 may further consider to perform relay reselection or try to establish a direct connection to the source gNB 101 or to another gNB in proximity (e.g. direct connection to gNB 102).

Therefore, in an example, all or part of the following Information Elements are added (e.g. as CHO notification information of the CHO notification) to the CONDITIONAL HANDOVER INFORMATION message 313:
Relay CHO configuration notification information. This information is used to notify the Remote UE 111 that the Relay UE 110 has received one or more conditional handover (CHO) configurations from the source gNB 101. For example, this information may include information for indicating the relay UE has received one or more CHO configurations for one or more CHO candidate target cells). The Relay CHO configuration notification information may be a flag which when set indicates the Relay UE 110 has received one or more CHO configurations or when not set indicates the Relay UE 110 has not received any CHO configurations. The flag may be, for example, a field in the CONDITIONAL HANDOVER INFORMATION message 313 which when set to a certain value indicates the Relay UE 110 has received one or more CHO configurations.
Relay CHO configuration information. This information is used to provide information on the Target Cell to be considered for each of the conditional handover (CHO) configurations received from the source gNB 101. For example, this information may include target cell information associated with one or more CHO candidate target cells with which the Relay UE has been configured to perform CHO). It may, for instance, include the target NR Cell Global Identity (NCGI), or the NR Cell ID (NCI), which includes the target gNB ID and the target Cell ID (CI), or only the target gNB ID, or only the target Cell ID (target CI). In one aspect, the Relay UE 110 may add an information related to the probability of performing a CHO for each of the considered target cells. The Relay UE 110 may thus provide a probability level, or ranking, for each of the potential target cell, or indicate which target cell is the most probable one to be selected for CHO.
Detach Request information. This information is used by the Relay UE 110 to request the Remote UE 111 to detach from it. The reception of this information may trigger the Remote UE to either perform relay reselection or try to connect to a nearby gNB.

If there is more than one Remote UE connected to the Relay UE 110, the Relay UE 110 may request all of the Remote UEs to detach from the Relay UE 110. In this case, the same CONDITIONAL HANDOVER INFORMATION message 313 may be sent to all of the served Remote UEs. Alternatively (e.g. even in the case when the Relay UE decides it will not request that any of the Remote UEs are to detach), or when the Relay UE 110 decides only some of the Remote UEs are to detach, a CONDITIONAL HANDOVER INFORMATION message 313 may be provided for each one of the Remote UEs.

The Relay UE 110 may, for example, evaluate CHO execution conditions (at 320) by performing measurements on the radio signals (e.g. reference signals) received from the serving cell controlled by source gNB 101, and radio signals received from the one or more CHO candidate target cells to determine certain measurement quantities (such as RSRP and/or RSRQ and/or SINR) and to then compare the relevant measurement quantities with the configured CHO execution conditions.

In one example, the CONDITIONAL HANDOVER INFORMATION message 313 may be the RRCReconfigurationSidelink message defined in TS 38.331 v17.1.0.

In one example, the CONDITIONAL HANDOVER INFORMATION message 313 may be the NotificationMessageSidelink message defined in TS 38.331 v17.1.0.

Upon reception of the CONDITIONAL HANDOVER INFORMATION message 313, the Remote UE 111 may evaluate the need for detaching from Relay UE 111 and perform relay reselection, based on the information included in this message and/or whether it wants to or would remain connected or not to the relay UE in case the relay UE actually performs CHO to one of the CHO candidate target cells with which the Relay UE has been configured to perform CHO (at 322).

For instance, the Remote UE 111 may wish to detach from the Relay UE 110 (which is moving to another gNB) rather than keep its PC5/sidelink connection in case the Remote UE 111 is a static UE node, or in case it estimates that the target cell the Relay UE is moving to is not suitable for the applications or services available on the remote UE. If none of the potential or candidate target cells, as identified by the Relay CHO configuration information, is acceptable for Remote UE 111, it may decide to detach from Relay UE 111. Otherwise, if at least one of the potential target cells for Relay UE CHO is acceptable for Remote UE 111, it may decide to remain connected to the Relay UE 110 until further notice.

On the other hand, the Remote UE 111 may have strong or close interactive relationship (e.g. applications/services on the remote UE 111 may interact with applications/services on the relay UE) with the Relay UE 110 (e.g. the Remote UE 111 may be a smart watch while the Relay UE 110 may be a smart phone). Such Remote UE may be referred to as a bounded Remote UE. Therefore, Remote UE 111 may wish to remain connected to Relay UE 110 when Relay UE 110 performs a conditional handover (CHO).

The Remote UE 111 may further issue a CONDITIONAL HANDOVER INFORMATION RESPONSE message 314 to inform the Relay UE 110 on its intention to remain connected to the Relay UE 110 or to detach from it in case the Relay UE 110 would perform a conditional handover (CHO). For example, the remote UE 111 may send remote UE CHO information indicating whether or not the at least one of the one or more remote UEs would remain connected to the relay UE after the relay UE executes/performs CHO.

Therefore, in an example, all or part of the following Information Elements are added (e.g. as remote UE CHO information) to the CONDITIONAL HANDOVER INFORMATION RESPONSE message 314:
CHO Connection information. This information is used to indicate to the Relay UE 110 information on the one or more target Cells (as indicated in the Relay CHO configuration information of the previously received CONDITIONAL HANDOVER INFORMATION message 313) for which Remote UE 111 would remain connected to the Relay UE 110. For example, this information may include connection identification information associated with each of the one or more candidate target cells for which the at least one remote UE would remain connected to the relay UE after the relay UE executes/performs CHO. As discussed above, the connection identification information may include the target cell NCGI, or the target cell NCI, or only the target gNB ID, or only the target CI.
CHO Detach information. This information is used to indicate to the Relay UE 110 information on the one or more target Cells (as indicated in the Relay CHO configuration information of the previously received CONDITIONAL HANDOVER INFORMATION message 313) for which Remote UE 111 would detach from the Relay UE 110. For example, this information may include detach identification information associated with each of the one or more candidate target cells for which the at least one remote UE would not remain connected to (i.e. would detach from) the relay UE after the relay UE executes/performs CHO. As discussed above, the connection identification information may include the target cell NCGI, or the target cell NCI, or only the target gNB ID, or only the target CI.

In one example, the CONDITIONAL HANDOVER INFORMATION RESPONSE message 314 may be the RRCReconfigurationSidelinkComplete message defined in TS 38.331 v17.1.0. In such case, the CONDITIONAL HANDOVER INFORMATION RESPONSE message 314 may carry only the CHO Connection information or may carry both the CHO Connection information and the CHO Detach information.

In one example, the CONDITIONAL HANDOVER INFORMATION RESPONSE message 314 may be the RRCReconfigurationFailureSidelink message defined in TS 38.331 v17.1.0. In such case, only the CHO Detach information would be added to the CONDITIONAL HANDOVER INFORMATION RESPONSE message 314.

The information carried by the received CONDITIONAL HANDOVER INFORMATION RESPONSE message 314 may be forwarded (or information based on the remote UE CHO information received in the CONDITIONAL HANDOVER INFORMATION RESPONSE message 314 may be sent) to the source gNB 101 by the Relay UE 110 using the REMOTE UE INFORMATION message 315. Such information may allow the source gNB 101 to anticipate some potential Remote UE handover(s) (HO) and further anticipate some handover negotiation for these UEs.

Therefore, in an example, all or part of the following Information Elements may be added (e.g. as remote UE information) to the existing REMOTE UE INFORMATION message 315:
List of CHO connected Remote UEs information. This information is used to indicate, for a given target cell configured at the Relay UE 110 as a potential target for CHO, the number and/or the ID of the Remote UEs that would remain connected to the Relay UE 110 once it has completed its handover to this target cell. If there are more than one potential or candidate target cells configured at the Relay UE 110, a List of CHO connected Remote UEs may be provided for each of the candidate target cells.
List of Bounded Remote UEs information. This information is used to indicate the number and/or the ID of the Remote UEs that have a certain relationship with the Relay UE (e.g. the certain relationship is a strong or close interactive relationship and is based on a relationship which is additional to being wirelessly connected to or served by the Relay UE, such as having applications or services which interact with applications or services on the Relay UE). Some Remote UEs may have strong or close interactive relationship with the Relay UE 110 (e.g. the Remote UE may be a smart watch while the Relay UE may be a smart phone). Thus, such Remote UEs may wish to remain connected to this Relay UE 110 when it performs a handover (HO) or a conditional handover (CHO). Such Remote UEs may be referred to as bounded Remote UEs. In one example, the Relay UE 110 may inform its source gNB 101 about its bounded Remote UEs by sending the list or the number of bounded Remote UEs it is serving in a REMOTE UE INFORMATION message 315.
List of CHO connected Remote UE Requirements information. This information gathers, for each of the Remote UEs in the List of CHO connected Remote UEs and/or List of Bounded Remote UEs information, some specific requirements (e.g. communication requirements) such as QoS requirements (e.g. a minimum QoS level, or a maximum QoS level, or an average QoS level) or some bitrate requirements (e.g. a minimum bitrate, or a maximum bitrate, or average bitrate) or load requirements for each of the considered or respective Remote UEs.

In one example, the REMOTE UE INFORMATION message 315 used to carry the aforementioned information is the SidelinkUEinformationNR message, defined in 3GPP TS 38.331 v17.1.0.

In one aspect, the RECONFIGURATION NOTIFICATION message 311 may include an information indicating that the Relay UE should issue a CONDITIONAL HANDOVER INFORMATION message 313 to its served Remote UE(s).

In one example, the REMOTE UE INFORMATION message 315 used to carry the aforementioned information is the RRCReconfigurationComplete message defined in TS 38.331 v17.1.0. In such case, the Relay UE 110 would not send the RECONFIGURATION COMPLETE message 312 but rather issue a CONDITIONAL HANDOVER INFORMATION message 313, wait for the reception of a CONDITIONAL HANDOVER INFORMATION RESPONSE message 314 then send to the source gNB 101 the REMOTE UE INFORMATION message 315.

Upon reception of the REMOTE UE INFORMATION message 315 from the Relay UE 110, the source gNB 101 may further negotiate with the potential target gNBs considered in the RECONFIGURATION CONFIGURATION message 311, the handover of all or part of the Remote UEs referenced in the List of CHO connected Remote UEs and/or List of Bounded Remote UEs information. As part of the negotiation, the source gNB 101 may determine (e.g. from handover accept or status information sent by the target gNBs of the potential or candidate target cells indicating whether the handover of the relay UE and/or all or some of the remote UEs connected to the relay UE has been accepted) whether handover of the Relay UE 110 and/or handover of the Remote UEs served by the Relay UE 110 and referenced in the List of CHO connected Remote UEs and/or List of Bounded Remote UEs information can be accepted by the target gNBs of the potential or candidate target cells. The negotiation process is not shown in FIG. 3a or 3b to simplify the message flows in FIGS. 3a and 3b.

The source gNB 101 may return to the Relay UE 110 a REMOTE UE INFORMATION RESPONSE message 319, which includes a Handover Granted List information which indicates, for each of the potential target gNBs, or target cells, considered in the RECONFIGURATION CONFIGURATION message 311, the list of the Remote UE(s) for which a handover would be accepted.

As mentioned earlier, after receiving a CHO configuration in the RECONFIGURATION NOTIFICATION message 311, the Relay UE 110 may maintain the connection with the source gNB 101 and start evaluating the CHO execution conditions for the candidate cell(s), including the cell managed by the target gNB 102 (as represented by 320 and 324). The evaluation process of the CHO execution conditions at 324 is substantially the same as the evaluation process at 320. If at least one CHO candidate cell satisfies the corresponding CHO execution condition(s), like for instance the cell managed by the target gNB 102, the Relay UE 110 may notify the Remote UE 111 that it will perform a handover by sending a CONDITIONAL HANDOVER NOTIFICATION message 316. For example, the Relay UE 110 may send another CHO notification (e.g. in a CONDITIONAL HANDOVER NOTIFICATION message 316) indicating the Relay UE 110 is to perform CHO. The CHO notification sent in message 313 may be considered a first CHO notification and the CHO notification sent in message 316 may be considered a second CHO notification. Thus, in an example, when certain handover execution conditions for CHO are met for at least one of the one or more CHO candidate target cells, the Relay UE 110 may send to the Remote UEs served by the Relay UE 110 another or second CHO notification indicating the Relay UE 110 is to perform or execute CHO to a target cell for which the CHO execution condition(s) have been met.

By notifying the served Remote UE(s) that the Relay UE 110 is to perform CHO to a target cell, the Relay UE 110 may allow its served Remote UE(s) (such as Remote UE 111) to decide whether it should remain connected to the Relay UE 110 or whether it should detach from Relay UE 110 and, for instance, perform relay reselection or try to establish a direct connection to the source gNB 101 or to another gNB in proximity, as previously discussed.

Therefore, in one example, all or part of the following Information Elements are added (e.g. as CHO notification information of another/second CHO notification) to the CONDITIONAL HANDOVER NOTIFICATION message 316:
Relay CHO notification information. This information is used to notify the Remote UE 111 that the Relay UE 110 is now performing a conditional handover (CHO) or is to perform.
Relay CHO configuration information. This information is used to provide information on the Target Cell selected by the Relay UE for performing its conditional handover (CHO). It may, for instance, include the target NR Cell Global Identity (NCGI), or the NR Cell ID (NCI), which includes the target gNB ID and the target Cell ID (CI), or only the target gNB ID, or only the target Cell ID (target CI).
Detach Request information. This information is used by the Relay UE 110 to request the Remote UE 111 to detach from it. The Remote UE may then either perform relay reselection or try to connect to a nearby gNB. In one aspect, based on the information received in the Handover Granted List information included in the REMOTE UE INFORMATION RESPONSE message 319, the Relay UE 110 may request a Remote UE which handover to the target cell referenced by the Relay CHO configuration was not accepted, to detach.

In one example, the CONDITIONAL HANDOVER NOTIFICATION message 316 may be the RRCReconfigurationSidelink message defined in TS 38.331 v17.1.0.

In one example, the CONDITIONAL HANDOVER NOTIFICATION message 316 may be the NotificationMessageSidelink message defined in TS 38.331 v17.1.0.

Then the Relay UE 110 may further detach from the source gNB 101, apply the corresponding configuration received from the source gNB 101 for the selected candidate cell, e.g. the cell managed by target gNB 102, synchronise to that candidate cell (at 326) and complete the RRC handover procedure by sending to the target gNB 102 the RECONFIGURATION COMPLETE message 317, such as the RRCReconfigurationComplete message defined in TS 38.331 v17.1.0. The Relay UE may further release the stored CHO configurations after successful completion of its RRC handover procedure with the target gNB 102.

Upon reception of the CONDITIONAL HANDOVER NOTIFICATION message 316, the Remote UE 111 may evaluate (at 322) the need for detaching from Relay UE 111, based on the information included in this message.

In case Remote UE 111 decides to keep its PC5 connection with Relay UE 110, it may initiate the re-establishment procedure with the target gNB 102 and send a REESTABLISHMENT REQUEST message 318 to the target gNB 102.

In one example, the REESTABLISHMENT REQUEST message 318 may be the RRCReestablishmentRequest message defined in TS 38.331 v17.1.0.

Referring now also to FIG. 3b which shows another example message flow in accordance with an embodiment of the invention. In FIG. 3b, the same messages/steps as shown in and described with reference to FIG. 3a are referenced by the same reference numeral and the above description of these message/steps applies with respect to the message flow of FIG. 3b.

In the example message flow shown in and described with reference to FIG. 3b, after receiving the RECONFIGURATION NOTIFICATION message 311, the Relay UE 110 may not send a CONDITIONAL HANDOVER INFORMATION message 313 to Remote UE 111 as shown in FIG. 3a. In such case, the Relay UE 110 will just start evaluating the CHO execution conditions for the candidate cell(s) (at step 324) and, at some point, if at least one CHO candidate cell satisfies the corresponding CHO execution condition, it will send a CONDITIONAL HANDOVER NOTIFICATION message 316 to the Remote UE 111 as mentioned earlier. For example, the Relay UE 110 may send a CHO notification indicating the Relay UE 110 has been configured to perform CHO and is to perform CHO. In an example, the CHO notification is sent (e.g. in a CONDITIONAL HANDOVER NOTIFICATION message 316) when certain handover execution conditions for CHO are met for a target cell and so the CHO notification indicates the relay UE is to perform CHO to a target cell for which the certain handover execution conditions for CHO are met. The CHO notification sent may include at least one of the Information Elements described above in relation to the CONDITIONAL HANDOVER NOTIFICATION message 316.

In other words, with the example message flow of FIG. 3a first and second CHO notifications are sent to the one or more Remote UEs (with the first CHO notification indicating the Relay UE 110 has been configured to perform CHO and the second CHO notification indicating the Relay UE 110 is to perform CHO) whereas with the example message flow of FIG. 3b, one CHO notification is sent to the one or more Remote UEs (the one CHO notification indicating the Relay UE 110 has been configured to perform CHO and is to perform CHO). Thus, the example message flow of FIG. 3b involves less signalling compared to the example message flow of FIG. 3a.

In either case, by providing CHO notification indicating the Relay UE has been configured to perform CHO, the one or more Remote UEs are provided with information enabling each of the Remote UEs to decide whether to stay connected to the Relay UE or to detach from the Relay UE. This helps to ensure that those Remote UEs that should stay connected to the Relay UE on CHO can stay connected and that other Remote UEs can make a decision as to whether to be handed over or not rather than being automatically handed over to a new gNB when the Relay UE performs CHO to the target gNB. The decision by the Remote UE can be based on a CHO notification indicating that the Relay UE has been configured to perform CHO. When the CHO notification includes additional information e.g. information associated with the target cell when CHO is to be performed and/or information associated with one or more candidate target cells, the Remote UEs have additional information with which to make the decision. For example, a Remote UE may want to stay connected to the Relay UE if CHO is performed to only one or some of the candidate target cells.

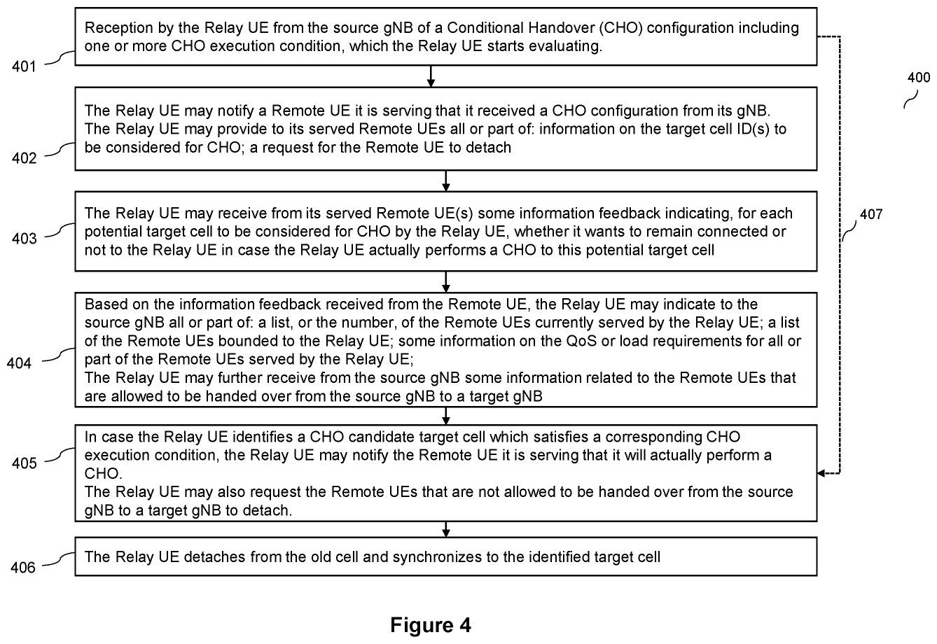

Referring now also to FIG. 4 which shows steps of an example method 400 for use in a process of managing Remote UE handover (HO) upon Relay UE conditional handover (CHO) according to embodiments of the invention.

The considered Relay UE is serving a plurality of Remote UEs and is connected to a source gNB.

The method 400 of FIG. 4 is performed at the Relay UE. For example, with reference to the wireless communication system shown in and described with respect to FIG. 1, the Relay UE performing the method 400 may be the Relay UE 110, the source gNB may be the source gNB 101, the target gNB may be the target gNB 102 and one or more of the Remote UEs served by the Relay UE 110 may include Remote UEs 111 and 112.

The method 400 as shown in and described with respect to FIG. 4 may be performed by software elements and/or hardware elements. Thus, for example, the method as shown in and described with respect to FIG. 4 may be performed by an apparatus for the Relay UE 110 comprising one or more processing units configured to carry out the method. The Relay UE may be implemented in a communication device 600 as shown in and described with reference to FIG. 6 with the method as shown in and described with respect to FIG. 6 being performed by one or more processing units, such as the central processing unit 611.

In step 401, the Relay UE (e.g. Relay UE 110) may receive from its serving base station (e.g. source base station 101), also referred to as source gNB 101, a RECONFIGURATION NOTIFICATION message 311, which may be the RRCReconfiguration message defined in TS 38.331 v17.1.0. This message may include CHO configuration information which may include one or more CHO execution conditions (as discussed above with respect to FIG. 3a), which the Relay UE 110 starts evaluating. An example of the evaluation of CHO execution conditions by the Relay UE 110 is discussed above with respect to step 320 in FIG. 3a.

Then, in step 402, the Relay UE may notify the Remote UEs it is serving, such as Remote UE 111, that it received a CHO configuration from its gNB, i.e. source gNB 101 by sending a CONDITIONAL HANDOVER INFORMATION message 313 to its served Remote UEs (e.g. a CHO notification indicating the Relay UE 110 has been configured to perform CHO).

The Relay UE 110 may include in the CHO notification at least one of: a Relay CHO configuration notification information used to notify the Remote UE 111 that the Relay UE 110 has received one or more conditional handover (CHO) configurations from the source gNB 101; a Relay CHO configuration information, used to provide information on the Target Cell to be considered for each of the conditional handover (CHO) configurations received by the Relay UE 110 from the source gNB 101, a Detach Request information, used by the Relay UE 110 to request the Remote UE 111 to detach from it. The Remote UE may then either perform relay reselection or try to connect to a nearby gNB. More information on the Information Elements that may be included in the CHO notification is given above with respect to the CONDITIONAL HANDOVER INFORMATION message 313.

In step 403, the Relay UE 110 may receive from its served Remote UEs, such as Remote UE 111, some information feedback (e.g. remote UE CHO information), via the CONDITIONAL HANDOVER INFORMATION RESPONSE message 314 discussed above with respect to FIG. 3a, indicating, for each potential or candidate target cell to be considered for CHO by the Relay UE 110, whether it wants to remain connected or not to the Relay UE 110 in case the Relay UE 110 actually performs a CHO to this potential target cell. In case the Relay UE 110 did not include a Relay CHO configuration information in the CONDITIONAL HANDOVER INFORMATION message 313 sent at step 402, a Remote UE may indicate to the Relay UE 110 its intention to remain connected or not to the Relay UE 110 in case the Relay UE actually performs a CHO, regardless of the target cell considered for this conditional handover (CHO).

In step 404, based on the information feedback received from the Remote UE in step 403, the Relay UE 110 may provide its serving gNB 101 with some information on one or more Remote UEs that are willing to remain connected to it in case of an effective Conditional handover (CHO), by sending a REMOTE UE INFORMATION message 315, as discussed above with respect to FIG. 3a.

The Relay UE 110 may include in the information feedback or the remote UE CHO information at least one of: a list of CHO connected Remote UEs, which indicates, for a given target cell configured at the Relay UE 110 as a potential target for CHO, the number and/or the ID of the Remote UEs that would remain connected to the Relay UE 110 once it has completed its handover to this target cell; a list of Bounded Remote UEs, i.e. Remote UEs having a strong or close interactive relationship with the Relay UE and that may wish to remain connected to this Relay UE when it performs a handover (HO) or a conditional handover (CHO); a list of CHO connected Remote UE Requirements information, which gathers, for each of the Remote UEs in the list of CHO connected Remote UEs, some specific requirements (e.g. communication requirements) such as QoS requirements (e.g. a minimum QoS level, or a maximum QoS level, or an average QoS level) or some bitrate requirements (e.g. a minimum bit rate, or a maximum bitrate, or average bitrate) or load requirements for each of the considered Remote UEs. Alternately, the list of CHO connected Remote UE Requirements information may gather some maximum or average requirements applying to the entirety of the Remote UEs in the list of CHO connected Remote UEs. More information on the Information Elements that may be included in the information feedback or the remote UE CHO information is given above with respect to the REMOTE UE INFORMATION message 315.

Also in step 404, in one example, the Relay UE 110 may further receive a message from its source gNB 101, such as REMOTE UE INFORMATION RESPONSE message 319, which includes a handover acceptance status (such as the Handover Granted List information), which indicates, for each of the potential target gNBs, or target cells, considered in the RECONFIGURATION CONFIGURATION message 311 issued at step 401, the list of the Remote UE(s) that are allowed to be handed over to said potential target gNBs. More information on the handover acceptance/status information is given above with respect to the REMOTE UE INFORMATION RESPONSE message 319.

In step 405, in case the Relay UE 110 identifies a CHO candidate target cell which satisfies a corresponding CHO execution condition amongst the one or more CHO execution conditions received at step 401, the Relay UE 110 may notify the one or more Remote UEs it is serving that it will actually perform a CHO by sending CONDITIONAL HANDOVER NOTIFICATION message 316 (e.g. by sending another CHO notification).

The Relay UE 110 may include in the another CHO notification at least one of: a Relay CHO notification information, which is used to notify the Remote UE that the Relay UE is now performing a conditional handover (CHO) or is to perform CHO; a Relay CHO configuration information, which is used to provide information on the Target Cell selected by the Relay UE for performing its conditional handover (CHO) and may, for instance, include the target NR Cell Global Identity (NCGI), or the NR Cell ID (NCI), which includes the target gNB ID and the target Cell ID (CI), or only the target gNB ID, or only the target Cell ID (target CI); a Detach Request information used by the Relay UE to request the Remote UE to detach from it. Based on the handover acceptance status the Relay UE may have received at step 404, the Relay UE may request the Remote UEs which handover was not accepted for the above CHO candidate target cell to detach. More information on the Information Elements that may be included in the another CHO notification is given above with respect to the CONDITIONAL HANDOVER NOTIFICATION message 316.

Eventually, in step 406, the Relay UE 110 may further, as part of performing or executing CHO, detach from its serving gNB 101, or source gNB 101, apply the corresponding configuration received from its serving gNB 101 for the selected candidate cell, synchronise to that candidate cell and complete the RRC handover procedure by sending to the target gNB 102 controlling the selected candidate cell the RECONFIGURATION COMPLETE message 317, such as the RRCReconfigurationComplete message defined in TS 38.331 v17.1.0. The Relay UE 110 may further release the stored CHO configurations after successful completion of its RRC handover procedure with the target gNB 102.

In another example, after receiving the RECONFIGURATION NOTIFICATION message 311 in step 401, the Relay UE 110 may not go through the steps 402, 403 and 404. In such case, the Relay UE may just start evaluating the CHO execution conditions for the candidate cell(s) and directly process step 405 as shown by the dotted line 407 in FIG. 4. This corresponds to the example message flow shown in and described with respect to FIG. 3b.

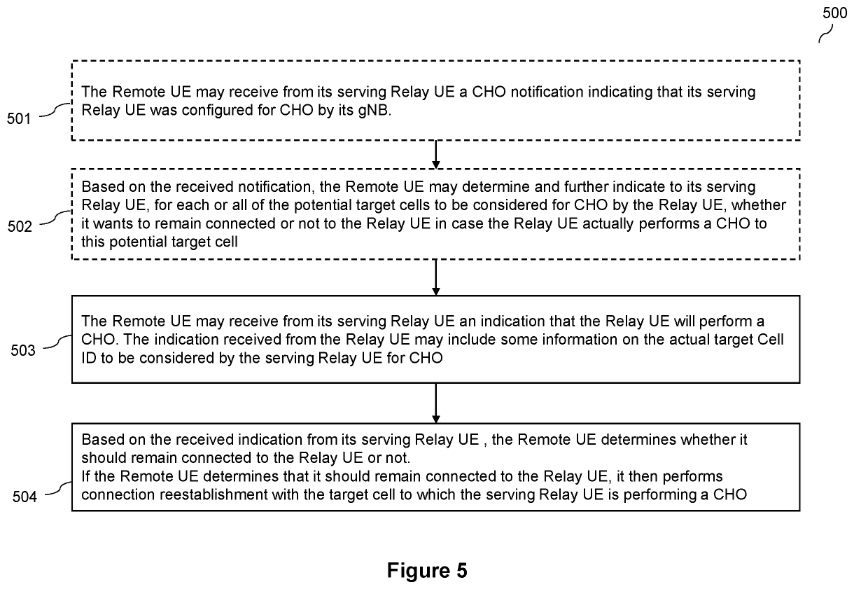

FIG. 5 shows steps of an example method 500 for use in a process of managing Remote UE handover (HO) upon Relay UE conditional handover (CHO) according to embodiments of the invention.

The considered Relay UE is serving a plurality of Remote UEs and is connected to a source gNB.

The method 500 of FIG. 5 is performed at the Remote UE. For example, with reference to the wireless communication system shown in and described with respect to FIG. 1, the Remote UE performing the method 500 may be the Remote UE 111, the source gNB may be source gNB 101, the target gNB may be the target gNB 102 and the Relay UE may be Relay UE 110 serving the Remote UE 111.

The method 500 as shown in and described with respect to FIG. 5 may be performed by software elements and/or hardware elements. Thus, for example, the method as shown in and described with respect to FIG. 5 may be performed by an apparatus for the source gNB comprising one or more processing units configured to carry out the method. The Remote UE may be implemented in a communication device 600 as shown in and described with reference to FIG. 6 with the method as shown in and described with respect to FIG. 6 being performed by one or more processing units, such as the central processing unit 611.

In step 501, the Remote UE 111 may receive a CONDITIONAL HANDOVER INFORMATION message 313 from the Relay UE 110 indicating that the Relay UE was configured by its serving gNB (e.g. source gNB 101) to perform Conditional Handover (CHO). For example, the Remote UE 111 receives a CHO notification indicating the Relay UE 110 has been configured to perform CHO. More information on the Information Elements that may be included in the CHO notification is given above with respect to the CONDITIONAL HANDOVER INFORMATION message 313.

In step 502, based on the information included in the received CONDITIONAL HANDOVER INFORMATION message 313, the Remote UE 111 may determine whether the Remote UE 111 would or wants to remain connected to the Relay UE 110 after the Relay UE 110 performs CHO (e.g. based, in part on the received CHO notification). More details of how the determination or evaluation may be performed by the Remote UE 111 is discussed above with reference to step 322 of FIG. 3a. Based on the determination, the Remote UE 111 indicates to its serving Relay UE 110, using for example a CONDITIONAL HANDOVER INFORMATION RESPONSE message 314, whether it wants to remain connected or not to the Relay UE in case the Relay UE actually performs CHO. In an example, where the CHO notification includes CHO configuration information indicating the relay UE has received one or more CHO configurations for one or more CHO candidate target cells, the Remote UE 111 indicates to its serving Relay UE 110, using a CONDITIONAL HANDOVER INFORMATION RESPONSE message 314, whether it wants to remain connected or not to the Relay UE in case the Relay UE actually performs a CHO to the one or more CHO candidate or potential target cells. In one aspect, the Remote UE 111 may indicate its intention to remain connected to the Relay UE 110 in case the Relay UE 110 actually performs a CHO for all or part of the potential target cells to be considered for Relay UE conditional handover. In another aspect, the Remote UE 111 may indicate its intention to remain connected to the Relay UE 110 in case the Relay UE 110 actually performs a CHO regardless of the potential target cell to be considered for Relay UE conditional handover.

In step 503, the Remote UE may be notified by its serving Relay UE 110, using a CONDITIONAL HANDOVER NOTIFICATION message 316 (e.g. another CHO notification), that the serving Relay UE 110 will perform a CHO. The indication or the another CHO notification received from the Relay UE 110 may include some information on the actual Target Cell ID to be considered by the serving Relay UE 110 for CHO. More information on the Information Elements that may be included in the another CHO notification is given above with respect to the CONDITIONAL HANDOVER NOTIFICATION message 316.

Then, in step 504, based on the information included in the CONDITIONAL HANDOVER NOTIFICATION message 316 received in step 503, the Remote UE 111 may determine whether it should remain connected to the Relay UE 110 or not based on the evaluation process performed in step 502. More details of how the determination or evaluation may be performed by the Remote UE 111 is discussed above with reference to step 322 of FIG. 3a.

If the Remote UE 111 eventually determines that it should keep its PC5 connection with and remain connected to its serving Relay UE 110, it may initiate a re-establishment procedure with the target gNB 102 that manages the target cell to which the serving Relay UE 110 is to be handed over and send a REESTABLISHMENT REQUEST message 318 to this target gNB 102.

In another example, the Remote UE 111 may only receive CONDITIONAL HANDOVER NOTIFICATION message 316 from its serving Relay UE 110, i.e. the serving Relay UE may not send any CONDITIONAL HANDOVER INFORMATION message 313 to its served Remote UE(s). In such case, the method 500 of FIG. 5 may start at step 503. This corresponds to the example message flow shown in and described with respect to FIG. 3b.

FIG. 6 shows a schematic representation of an example communication device or station, in accordance with one or more example embodiments of the present disclosure.

The communication device 600 may be a device such as a micro-computer, a workstation or a light portable device. The communication device 600 comprises a communication bus 613 to which there are preferably connected:
a central processing unit 611, such as a microprocessor, denoted CPU;
memory for storing data and computer programs containing instructions for the operation of the communication device 1000. The computer programs may contain a number of different program elements or sub-routines containing instructions for a variety of operations and for implementing the invention. For example, the program elements include at least one element for managing handover of a relay UE as discussed above. The at least one element when executed by the central processing unit 1011 configure the processing unit (and hence the communication device 1000) to perform the method(s) as described above.

The communication device 1000 may further comprise at least one communication interface 602 connected to the radio communication network 603 over which digital data packets or frames or control frames are transmitted, for example a wireless communication network according to the Release 16 for 5G NR. The frames are written from a FIFO sending memory in RAM 612 to the communication interface 602 for transmission or are read from the communication interface 602 for reception and writing into a FIFO receiving memory in RAM 612 under the control of a software application running in the CPU 611.

Each of a UE and base station may comprise such a communication device 1000.

The central processing unit 1011 may be a single processing unit or processor or may comprise two or more processing units or processors carrying out the processing required for the operation of the communication device 1000. The number of processing units or processors and the allocation of processing functions to the processing unit(s) is a matter of design choice for a skilled person.

The memory may include:
a read only memory 607, denoted ROM, for storing computer programs for implementing methods according to embodiments of the invention;
a random-access memory 612, denoted RAM, for storing the executable code of methods according to embodiments of the invention as well as the registers adapted to record variables and parameters necessary for implementing methods according to embodiments of the invention;

Optionally, the communication device 600 may also include the following components:
a data storage means 604 such as a hard disk, for storing computer programs for implementing methods according to one or more embodiments of the invention;
a disk drive 605 for a disk 606, the disk drive being adapted to read data from the disk 606 or to write data onto said disk;
a screen 609 for displaying decoded data and/or serving as a graphical interface with the user, by means of a keyboard 610 or any other user input means.

Preferably the communication bus 613 provides communication and interoperability between the various elements included in the communication device 600 or connected to it. The representation of the bus 613 is not limiting and in particular, the central processing unit is operable to communicate instructions to any element of the communication device 600 directly or by means of another element of the communication device 600.

The disk 606 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 607, on the hard disk 604 or on a removable digital medium such as for example a disk 606 as described previously. According to an optional variant, the executable code of the programs can be received by means of the communication network 603, via the communication interface 602, in order to be stored in one of the storage means of the communication device 600, such as the hard disk 604, before being executed.

The central processing unit 611 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 604 or in the read only memory 607, are transferred into the random-access memory 612, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC). In such a case, logic units are configured to perform the steps of the method(s) in accordance with the present invention described above.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for use in managing conditional handover, CHO, of a relay user equipment, UE, from a source base station to a target base station, the relay UE serving one or more remote UEs via one or more sidelink connections, the method at the relay UE comprising:
sending, to the one or more remote UEs, a CHO notification indicating the relay UE has been configured to perform CHO.

2. The method of claim 1, wherein the CHO notification includes at least one of:
relay CHO configuration notification information for indicating the relay UE has received one or more CHO configurations for one or more CHO candidate target cells;
target cell information associated with one or more CHO candidate target cells with which the relay UE has been configured to perform CHO;
detach request information for requesting at least one of the one or more remote UEs detaches from the relay UE.

3. (canceled)

4. The method of claim 2, wherein a CHO notification is provided for each of the one or more remote UEs, wherein the CHO notification for a respective one of the one or more remote UEs further includes detach request information for requesting the respective one of the one or more remote UEs detaches from the relay UE.

5. (canceled)

6. The method of claim 2, wherein the target cell information includes for each CHO candidate target cell of the one or more CHO candidate target cells an identifier of the candidate target cell and/or an identifier of a target base station controlling the candidate target cell, wherein the target cell information further includes probability information for indicating the probability of the relay UE performing CHO for the one or more CHO candidate target cells.

7. (canceled)

8. The method of claim 1, wherein the CHO notification includes a request for information from the at least one remote UE to confirm whether the at least one remote UE would remain connected to the relay UE after the relay UE performs CHO.

9. The method of claim 1, further comprising receiving from at least one of the one or more remote UEs remote UE CHO information indicating whether the at least one of the one or more remote UEs would remain connected to the relay UE after the relay UE performs CHO.

10. The method of claim 9, wherein the remote UE CHO information indicates for the at least one of the one or more candidate target cells whether the at least one of the one or more remote UEs would remain connected to the relay UE after the relay UE performs CHO to a respective candidate target cell.

11. The method of claim 10, wherein the remote UE CHO information includes at least one of:
connection identification information associated with each of the one or more candidate target cells for which the at least one remote UE would remain connected to the relay UE after the relay UE performs CHO;
detach identification information associated with each of the one or more candidate target cells for which the at least one remote UE would not remain connected to the relay UE after the relay UE performs CHO.

12. The method of claim 1, further comprising sending another CHO notification indicating the relay UE is to perform CHO.

13. (canceled)

14. The method of claim 12, wherein the another CHO notification includes at least one of:
relay CHO notification information for indicating that the relay UE is to perform CHO to a target cell;
target cell information associated with the target cell with which the relay UE is to perform CHO;
detach request information for requesting at least one of the one or more remote UEs detaches from the relay UE.

15. (canceled)

16. The method of claim 12, wherein in the case where certain handover execution conditions for CHO are met for two or more candidate target cells, the method further comprises sending, to the one or more remote UEs, the another CHO notification indicating the relay UE is to perform CHO to one of the two or more candidate target cells.

17. The method of claim 1, wherein sending the CHO notification includes sending the CHO notification indicating the relay UE has been configured to perform CHO and is to perform CHO.

18. The method of claim 17, wherein sending the CHO notification comprises sending the CHO notification when certain handover execution conditions for CHO are met for a target cell, the method further comprising sending, to the one or more remote UEs, the CHO notification indicating the relay UE is to perform CHO to a target cell for which the certain handover execution conditions for CHO are met.

19. The method of claim 17, wherein the CHO notification includes at least one of:
relay CHO notification information for indicating that the relay UE is to perform CHO to a target cell;
target cell information associated with the target cell with which the relay UE is to perform CHO.

20. (canceled)

21. (canceled)

22. The method of claim 1, further comprising receiving, from the source base station, CHO configuration information for configuring the relay UE to perform CHO.

23. The method of claim 22, wherein the CHO configuration information includes for each of one or more CHO candidate target cells:
configuration of a CHO candidate target cell to be used by the relay UE to access the CHO candidate target cell;
one or more CHO execution conditions to be met before handover to the CHO candidate target cell can be performed.

24. The method of claim 1, further comprising:
sending, to the source base station, remote UE information, wherein the remote UE information includes at least one of:
list of remote UEs information for indicating at least one of the number and the identifiers of the one or more remote UEs that would remain connected to the relay UE after the relay UE performs CHO;
list of bounded remote UEs information for indicating at least one of the number and the identifiers of the remote UEs having a certain relationship with the relay UE;
CHO connected remote UE requirement information for indicating communication requirements for the one or more remote UEs that would remain connected to the relay UE after the relay UE performs CHO.

25. The method of claim 24, further comprising receiving, from the source base station, handover status information indicating whether respective target base stations of one or more CHO candidate target cells have accepted handover of the relay UE and/or all or some of the one or more remote UEs served by the relay UE.

26. (canceled)

27. A method at a remote user equipment, UE, being served by a relay UE via one or more sidelink connections, the method comprising:
receiving, from the relay UE, CHO notification indicating that the relay UE has been configured to perform CHO.

28. The method of claim 27, further comprising determining, based on the received CHO notification, whether the remote UE wants to remain connected to the relay UE after the relay UE performs CHO.

29. The method of claim 28, further comprising detaching from the relay UE in response to determining the remote UE does not want to remain connected to the relay UE after the relay performs CHO or performing a re-establishment procedure in response to determining the remote UE does want to remain connected to the relay UE after the relay performs CHO and when the relay UE performs or is to perform CHO.

30. The method of claim 27, wherein the CHO notification includes at least one of:
relay CHO configuration notification information for indicating the relay UE has received one or more CHO configurations for one or more CHO candidate target cells;
target cell information associated with one or more CHO candidate target cells with which the relay UE has been configured to perform CHO;
detach request information for requesting the remote UE detaches from the relay UE.

31. (canceled)

32. The method of claim 30, wherein the target cell information includes for each CHO candidate target cell of the one or more CHO candidate target cells an identifier of the candidate target cell and/or an identifier of a target base station controlling the candidate target cell, wherein the target cell information further includes for each CHO candidate target cell of the one or more CHO candidate target cells probability information for indicating the probability of the relay UE performing CHO for the CHO candidate target cell compared to other CHO candidate target cells.

33. (canceled)

34. The method of claim 27, wherein the CHO notification includes a request for information from the remote UE to confirm whether the remote UE would remain connected to the relay UE after the relay UE performs CHO.

35. The method of claim 27, further comprising sending, to the relay UE, remote UE CHO information indicating whether the remote UE would remain connected to the relay UE after the relay UE performs CHO.

36. (canceled)

37. The method of claim 35, wherein the remote UE CHO information includes at least one of:
connection identification information associated with each of the one or more candidate target cells for which the at least one remote UE would remain connected to the relay UE after the relay UE performs CHO;
detach identification information associated with each of the one or more candidate target cells for which the at least one remote UE would not remain connected to the relay UE after the relay UE performs CHO.

38. The method of claim 27, further comprising receiving another CHO notification indicating the relay UE is to perform CHO.

39. The method of claim 38, further comprising determining, based on the received another CHO notification, whether the remote UE wants to remain connected to the relay UE after the relay UE performs CHO.

40. The method of claim 38, wherein the another CHO notification includes at least one of:
relay CHO notification information for indicating that the relay UE is to perform CHO to a target cell;
target cell information associated with the target cell with which the relay UE is to perform CHO;
detach request information for requesting the remote UE detaches from the relay UE.

41. (canceled)

42. The method of claim 27, wherein receiving the CHO notification includes receiving the CHO notification indicating the relay UE has been configured to perform CHO and is to perform CHO.

43. (canceled)

44. (canceled)

45. Apparatus for a User Equipment, UE, the apparatus comprising:
one or more processing units configured to, in a case where the UE is operating as a relay UE serving one or more remote UEs:
send, to the one or more remote UEs, a CHO notification indicating the relay UE has been configured to perform CHO.

46. Apparatus for a User Equipment, UE, the apparatus comprising:
one or more processing units configured to, in a case where the UE is operating as a remote UE being served by a relay UE:
receive, from the relay UE, a CHO notification indicating the relay UE has been configured to perform CHO.

47. (canceled)

48. (canceled)

49. A non-transitory computer-readable storage medium carrying a computer program comprising instructions adapted to perform, when executed by one or more processing units of a remote User Equipment, UE, and in a case where the remote UE is being served by a relay UE via one or more sidelink connections, a method comprising receiving, from the relay UE, CHO notification indicating that the relay UE has been configured to perform CHO from a source base station to a target base station.
